(19) United States
(12) Patent Application Publication
(10) Pub. No.: US 2012/0254792 A1
(43) Pub. Date: Oct. 4, 2012

(54) Method And System For Providing An HMI In A Process Control System For Monitoring And Control Of A Process

(76) Inventors: Kristoffer Husoy, Oslo (NO); Torgeir Enkerud, Oslo (NO)

(21) Appl. No.: 13/524,272

(22) Filed: Jun. 15, 2012

Related U.S. Application Data
(63) Continuation of application No. PCT/EP2009/067259, filed on Dec. 16, 2009.

(51) Int. Cl. G06F 3/048

(52) U.S. Cl. 715/782; 715/800

(57) ABSTRACT

A method for navigating in a process control system. The process control system includes a graphical user interface with a plurality of graphic objects each associated with a process control object wherein a graphic object has an active link for monitoring or controlling at least one physical control object. The graphical user interface is arranged with navigation means so that a user can indicate or select one point in a process section on the graphical user interface as a first user input and increase, in a continuous animated movement, the scale at which the point and its immediate surroundings in the process section are displayed. Further, the zooming-in or zooming out continues displaying a view of the indicated or otherwise selected point on the graphical user interface and scaling it up continuously until a predetermined scale is reached or, until a second user input is received.

### CROSS-REFERENCE TO RELATED APPLICATIONS

The present application is a continuation of pending International patent application PCT/EP2009/067259 filed on Dec. 16, 2009 which designates the United States and the content of which is incorporated herein by reference.

### FIELD OF THE INVENTION

The present invention is concerned with providing an improved operations interface and navigation tool in a user interface in an industrial control system or process control system. In particular it is concerned with a method and system for providing a graphical user interface or human-machine interface (HMI) in a process control system for monitoring and control of a process.

### BACKGROUND OF THE INVENTION

Computer based control systems are widely used in a number of different industrial environments, such as for instance pulp and paper process and oil and gas production processes and electrical power production processes. There is a continual and generally increasing requirement for information about plant equipment, current and historic process data, trends, etc to carry out supervision and control of processes, industrial plants and production facilities. This information is typically provided by the control system and usually in the form of one or more distributed control systems (DCS) and/or supervisory control and data acquisition (SCADA) systems.

The information is typically presented to the operators through a display screen showing a number of different process graphics that each presents process data (measurements, values), tag identifiers, equipment ID, alarm status, connections between plant equipment, etc for a given process or process section. As more and more data is presented to the operators, the number of process graphics increase and visual user interfaces often hold very much information.

The task of finding the relevant technical information for a given technical subject or condition in a large information space is further complicated by the fact that in many situations the operator often has limited time available to make a decision. The significance of the information available will vary with the current situation. That is, users of industrial control systems have to deal at least in part with a problem of what is relevant in a given context, context sensitivity, as in some contexts certain information will be essential and in other contexts irrelevant.

Operators today often find it difficult or cumbersome to navigate around the process graphics to find the information they seek. New operators spend massive amounts of time getting to know the process graphics, to learn which information is located where and especially how to move from viewing one process graphic to view another process graphic. Furthermore, viewing several process graphics at the same time is technically possible today, but is difficult to use in practice. The most used solution for this is to have several monitors/windows and navigate each of these independently. It is common to find several display screens arranged on an operator desk, so that the operator has several views/displays open in front of him/her in order be able to view or find the desired information quickly.

Another concern for operators using control systems is the number of separate operator actions, meaning the number of selections or “clicks” of a computer mouse that are required to move around from one set of process information to another, especially when searching for a certain set of process information.

DE102008011156, entitled “Function e.g. zoom-in function, executing method for e.g. graphical representation at monitor of desktop involves fixing area at output device, and activating function relative to area depending on movement direction of input device”, assigned to Siemens AG discloses a method for zooming in to a graphic user interface. Zooming by moving an input device such as mouse, keyboard, touch pen, light pen and finger, of a computer. Functions e.g. zoom in and zoom out functions, are activated relative to the area depending on directions of a movement of the input device, where one of the movement directions runs parallel and opposite to the other movement direction. The area, eg a rectangle, is selected by a user. The function and the movement direction of the input device are selected by a user. The user can zoom-in or zoom-out from the selected area.

### SUMMARY OF THE INVENTION

The aim of the present invention is to remedy one or more of the above mentioned problems. This and other aims are obtained by a method for navigating in a process control system for monitoring and control of a process comprising a plurality of physical objects.

In a first aspect of the invention a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, and further by displaying a view of the indicated or otherwise selected point on said graphical user interface and scaling up continuously until a predetermined scale is reached or a second user input is received, and displaying a scaled-up view of the indicated or otherwise selected at least one point at the scaled-up level thus reached.

According to an embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising calculating, upon receiving the first user input to zoom in, an adjustment to scale of resolution for the process section on said graphical user interface including the indicated or selected at least one point.

According to an embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising visibly displaying in the scaled up view of on said graphical user interface the indicated or selected at least one point any text information that is in a predetermined size range.

According to another embodiment the method further includes visibly displaying in the scaled up view on said graphical user interface of the indicated or otherwise at least one selected point a graphic form or information that is within a predetermined size range. An advantage here is that unreadable information is taken away, reducing screen clutter.

According to an embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising scaling the at least one indicated or selected point on said graphical user interface by scaling up a vector based graphic image of one or more parts of said first process graphic.

According to an embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising increasing the display resolution smoothly and continuously for the at least one indicated or selected point on said graphical user interface until a maximum scale value is reached and overlaying new information objects which comprises more detailed information not displayed under magnification of the point or points while scaling up to the maximum scale value. Thus information not previously retrieved and displayed is subsequently retrieved and displayed when the resolution scale is such that the text and/or graphic would be visible.

According to another embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising increasing the display resolution on said graphical user interface smoothly and continuously for the at least one indicated or selected point until a scale value is reached at which point a detailed process information in a process section displayed with aggregated alarms becomes visible to an operator and changing from the aggregated graphic form to a detailed process information form showing one or more of the previously alarms (A3) in more detail. It is an advantage that the graphical user interface may be configured to zoom-in or zoom-out in one or more steps according to one of a number of selected criteria regarding process section level, location, function and the like.

According to another embodiment the method further includes increasing the display resolution on said graphical user interface smoothly and continuously for the at least one indicated or selected point until a scale value is reached at which point one or more data values become visible to an operator and then opening a data subscription for the latest or real-time values to each data value. In this way subscriptions to eg OPC real time data may be joined according to a preconfigured and semi automatic process.

According to another embodiment of the invention, a method is disclosed for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point in a process section on said graphical user interface as a first user input and increase, in a continuous animated movement, the scale at which the at least one point and its immediate surroundings in the process section are displayed, the method further comprising receiving a first user input to zoom-out from the at least one indicated or selected point on said graphical user interface and by, decreasing the display resolution of the selected part of the first process graphic in a smooth and continuous way and de-magnifying the at least one indicated or selected point until a predetermined scale is reached or a second user input is received, and displaying the control object at the magnification level reached at end of user input.

According to another embodiment the method further includes zooming out from the at least one indicated or selected point and changing, when one or more displayed alarms become smaller than a preset minimum scaling threshold, to aggregate the displayed alarms into another form on the display showing in which process section the previously displayed alarms belong.

According to another embodiment the method further includes moving to a scaled up or scaled down view from the at least one indicated or selected at least one point on said graphical user interface and displaying the scaled up or scaled down view of process information overlaid in a semi-transparent manner on top of the first view of the indicated or selected point on said graphical user interface.

According to another embodiment the method further includes moving to a scaled up or scaled down view of process information from said at least one indicated or selected point and fading in the scaled up or scaled down view of the process information until it is overlaid in a semi-transparent manner over the magnified/demagnified selected part of the indicated or selected point on said graphical user interface.

According to another embodiment the method further includes increasing or decreasing the display resolution smoothly and continuously until one or more predetermined scale or resolution stage is reached and then pausing the continuous smoothing at a stage predetermined to contain process information about any from the group of: a detail level; a process section level; process area level showing all process information and graphics within that area; functional group of process graphics, selected process information or process graphic graphics along with surrounding trends, faceplates, etc; part of process information graphics showing details of a specific equipment e.g. Export compressor, HP separator, LP Separator.

According to another embodiment the method further includes displaying a small representation overlaid on the active window showing in which area of all available process sections the currently selected part of the zoomed-in or zoomed out process information or process section is located. The advantage of this map view or radar view is that it facilitates navigation in the process and understanding of the layout of process sections relative to one another.

According to another embodiment the method further includes displaying at least one first process graphic of a process control system in an active window, and on receiving a user input to pan by panning in one direction (PL) or in a reverse direction over an extended artificial horizon extending almost up to 360 degrees.

According to another embodiment the method further includes providing a navigation means so that a user can indicate or select two or more points in a process section and zoom out continuously in one movement until the region between the two points fills the display area of a display screen.

The invention provides a graphical user interface for process information and related information where the process information is visually organized on an infinite virtual plane that can be seamlessly, continuously and smoothly zoomed-in to and zoomed-out from. It is a key point that the zoom and pan actions are represented as continuous and seamless animations/movements. The stepless transition provided by the continuous zoom-in or zoom-out helps the operator to understand the organisation of the process graphics displayed by the control system relative to the process or processes. The magnified view on the graphic interface may be provided by scaling up the resolution of a first image.

The invention may be applied in a control system for monitoring an industrial process such as, but not limited to, any the list of: industrial production; metal production; pulp and paper manufacture; automated industrial processes; oil and gas extraction or production, upstream or downstream processes; chemical industry equipment and processes, vehicle manufacturing, vehicle assembly. The graphical user interface may be used for checking a status of an industrial device, engineering an industrial device, making a calculated change to a set point or control parameter for an industrial device, configuring an automation device, controlling an automation device, tuning a process, checking a process variable, teaching a robot, editing a robot program. In addition the graphical user interface may also be applied to control systems used for monitoring equipment and/or retrieving technical data for devices used in conjunction with electricity generation, transmission, transformation and/or distribution.

In one embodiment vector based image files may be used and scaled up or scaled down in response to a user input. The magnified image may also be provided by smoothly or linearly interpolating between a first bitmap type image and a second bitmap type image. The magnified view of a graphic symbol on the graphic interface representing a control object controlled by the control system is preferably generated by a computer animation providing a transition between a first graphic image and a second graphic image and displaying a continuous magnification of “the first image” in that way. The continual zoom provides direction and visual or functional cues to a user or operator for navigation and/or orientation within the process control system.

Process information is in current systems normally organized into pages or views normally called process graphics or mimics. This is not necessarily the case for the proposed system, where process information objects do not necessarily need to be grouped into ‘process graphics’ or grouped entities, but rather be spread out on the infinitely large virtual plane individually. (thus the concept of ‘process graphics’ need not exist in the system at all). Thus some process graphics may be included as a part of a graphical user interface according to the invention but the invention is not based on, or limited to, a series of process graphics.

Additional, associated information from the process or an equipment in the process, such as an alarm list, trend display, faceplate, data sheet, manual, procedure description etc can be arranged alongside and/or on top of the set of process information for a process section or an equipment, and perhaps also arranged with process graphics in miniature size. Other information sources such as a live video feed, a picture, a 3D model, non-plant documentation may also be made available through the interface. These various process elements or documents associated with the process information, or with the process graphic when displayed at a certain level of detail, can be viewed by zooming further in.

The process graphics for a process or for a whole plant or installation can be organized according to different criteria, and be either statically organized or dynamically changeable by the system or user. The process information in the process graphics can optionally be grouped into layers, so that the operator or system can show/hide/change levels of salience on a layer of objects.

According to another aspect of the invention a process control system is disclosed which comprises a graphical user interface with a plurality of graphic objects each associated with a process control object wherein at least one graphic object has an active link for monitoring or controlling at least one physical control object, wherein said graphical user interface is arranged with navigation means so that a user can indicate or select at least one point on said graphical user interface as a first user input and increase the scale in a continuous animated movement at which the at least one point is displayed, and further displaying a view of the indicated or otherwise selected at least one point on said graphical user interface and scaling up continuously until a predetermined scale is reached or a second user input is received, and displaying a scaled-up view of the indicated or otherwise at least one selected point at the scaled-up level thus reached.

Each of a computer program, a computer program recorded on a computer-readable medium, and a computer program product are disclosed in another aspect of the invention.

### BRIEF DESCRIPTION OF THE DRAWINGS

A more complete understanding of the method and system of the present invention may be had by reference to the following detailed description when taken in conjunction with the accompanying drawings wherein:

FIG. 1 shows a schematic diagram of a plurality of process sections or process graphics shown laid out as a grid in a single view and arranged for continuous zooming in and/or out of the plane of view according to an embodiment of the invention;

FIG. 2 shows a schematic diagram of the invention shown in FIG. 1 in the form of a snapshot from a zoom-in to some of the plurality of process sections arranged for continuous zooming in and/or out of the plane of view;

FIGS. 3-5 show schematic diagrams of the invention shown in FIG. 1 in the form of a number of snapshots from a zoom-in to one of the plurality of process graphics, and associated faceplates, trends, arranged for continuous zooming in and/or out of the plane of view;

FIG. 6 shows a schematic diagram of the invention shown in FIG. 1 showing one process section of interest in a plane view of the plurality of process graphics, where the process sections graphics are organised in groups according to a functional or operational process context, and arranged for continuous zooming in and/or out of the plane of view;

FIG. 7 shows a schematic diagram of the invention shown in FIG. 1 showing a zoom-in to one process section of interest in a plane view of a process graphic with a faceplate and a trend, and showing a second process graphic of interest indicated for subsequent zoom-in as necessary, arranged for continuous zooming in and/or out of the plane of view;

FIG. 8 shows a schematic diagram of the invention shown in FIG. 1 and in particular showing a zoom-in view of the second process graphic of interest from FIG. 7 and also showing a third process graphic of interest for indicated for subsequent zoom-in as necessary, arranged for continuous zooming in and/or out of the plane of view;

FIG. 9 shows a schematic diagram of the invention shown in FIG. 1 and in particular showing a zoomed-in view of the third process graphic of interest from FIG. 8 and also showing a further fourth process graphic and faceplate, trend of interest indicated for subsequent zoom-in as necessary, arranged for continuous zooming in and/or out of the plane of view;

FIG. 10 shows a schematic diagram of the invention shown in FIG. 1 and in particular showing a zoomed-in view of the fourth process graphic of interest from FIG. 9 showing a compressor faceplate and trend of interest for subsequent zoom-in as necessary, arranged for continuous zooming in and/or out of the plane of view;

FIG. 11 shows a schematic diagram of the invention shown in FIG. 1 and in particular showing a zoomed-in view of the trend as shown with the compressor faceplate FIGS. 9, 10 and subsequent zoom-in as necessary, arranged for continuous zooming in and/or out of the plane of view;

FIG. 12 shows a schematic diagram of the invention shown in FIG. 1 and in particular showing a zoomed-out view of a process section in which less detailed graphic information has been substituted for more detailed graphic information as the scale of resolution has decreased below a predetermined level;

FIGS. 13-15 show schematic diagrams of the invention shown in FIG. 1 and in particular showing the additional of additional detailed information not previously visible during a sequence of zoom-ins, and FIG. 14 also shows a plant location reference guide or radar view indicator;

FIGS. 16A-16B show schematic diagrams of the invention shown in FIG. 1 and in particular a zoom-in to or zoom-out from a point indicating a marked area representing a process section;

FIGS. 17A-17B show schematic diagrams of the invention shown in FIG. 1 and in particular a zoom-in to or zoom-out from 2 points indicating a marked area representing a process section; and

FIG. 18 shows a schematic diagram of the invention shown in FIG. 1 and in particular showing a model of the graphical interface as a series of virtual planes arranged in 3-D space, each plane reached by zooming in or zooming out and each plane translatable left-right.

### DETAILED DESCRIPTION OF THE INVENTION

The process information or process graphics for a process or for a whole plant or installation can be organized according to different criteria, and be either statically organized or dynamically changeable by the system or user. The invention creates and provides a zooming or zoomable graphic interface for process information, process graphics and related information of a human-machine interface (HMI) of a process control system. The process information in the HMI may be visually organized on a series of infinite virtual planes, each one of which that can be seamlessly, continuously and smoothly navigated around. The navigation actions may be implemented and represented as continuous and seamlessly animated movements, as these continuous types of movements help the operator to understand the location of different process information in the system, provides direction, distance and other visual or functional cues for navigation and/or orientation.

In addition it provides a faster method to access the desired information, by providing a zoom-in as a continuous movement in response to user input until the desired information appears; then stopping the zoom-in in response to user input. A point or area of interest on the graphic interface only needs to be indicated in some way, then zoomed. The point or area does not have to be clicked on, or have a rectangle or other shape indicated on the display. The point of interest is pointed to, a zoom or pan input is made by the user, and a continuous zoom or pan relative to that indicated point begins. Additional information from the process or an equipment in the process, such as an alarm list, trend display, faceplate, data sheet, manuals, procedure descriptions etc can be shown in miniature size arranged alongside and/or on top of the process real time information at the same magnification as the process information. The user input may be registered to include a measure of desired speed of zooming. Thus a joystick or a scroll wheel for example may be registered as being held rotated over a wide angle and the corresponding zoom operation made at a faster speed. Conversely, a joystick or scroll wheel held at a narrow angle would operate the continuous zooming at a slow speed.

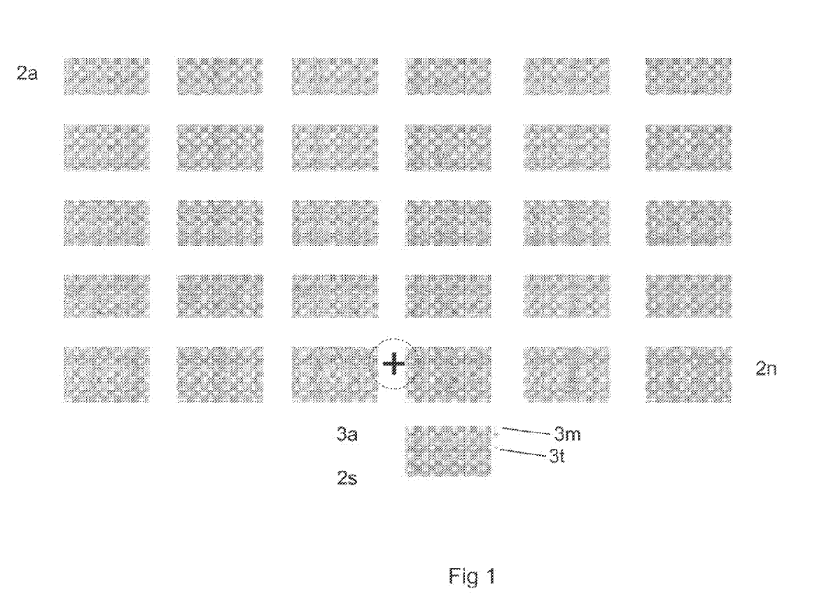

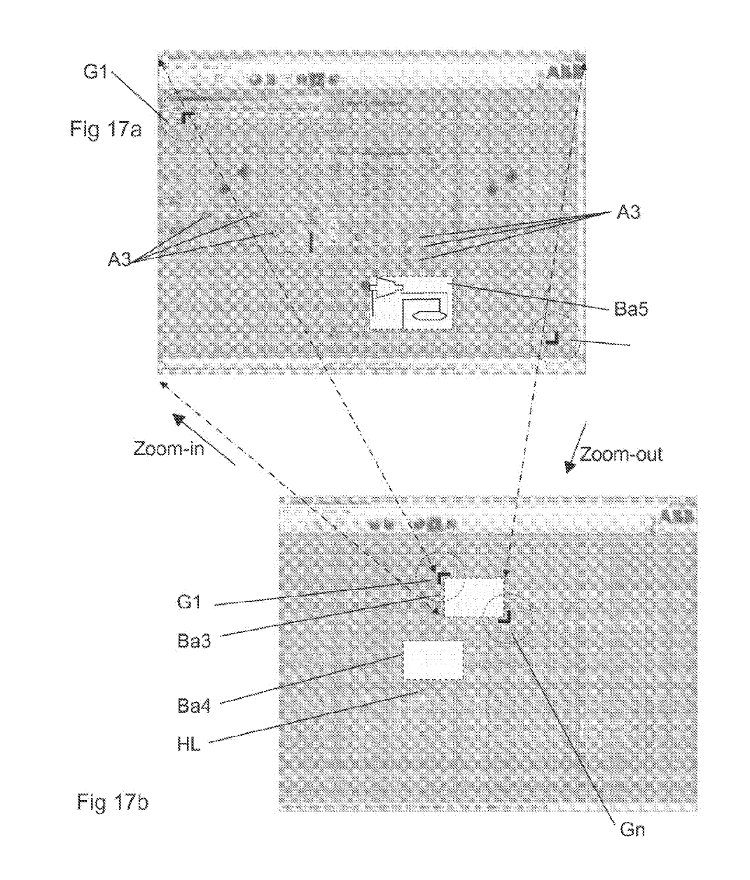

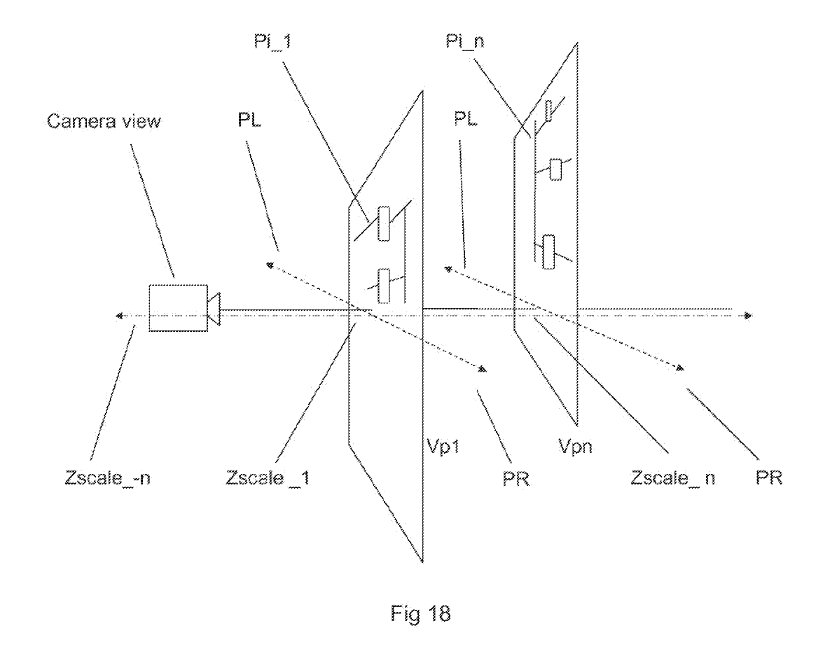

FIG. 18 is a schematic diagram of the functions of the graphical user interface. The figure illustrates how a camera on the left of the drawing may progressively zoom in from left to right focusing on a series of planes (virtual planes). FIG. 18 shows a first endless virtual plane Vp_1 which is intersected by a perpendicular axis Zscale_-n to Zscale_n. This axis represents the zoom function, as an endless magnification scale from left and right in this figure (whereas the zoom axis is in-and-out of the page in the other FIGS. 1-17). FIG. 18 also shows for each virtual plane is another perpendicular axis, a translation axis PL and PR which represents endless panning Left or Right, into the page PL and out of the page PR. The virtual plane Vp_1 contains process information objects Pi_1 and this is displayed as the graphical interface at any instant to an operator. The figure also shows a second endless virtual plane Vp_n, which includes process information Pi_n where the resolution n is greater than Zscale_1 or resolution 1. Thus software or a computer program or application associated with the graphical user interface determines from the scale or resolution which one (Vp_1) of an infinite number of virtual planes (Vp_-n to Vp_n) is displayed in the graphical user interface. The translation number on the pan left PL and pan right PR axis determines which process information along the left-right scale is selected and presented in the display in the plane. Another way to describe this is to say it is zooming in 3-D. Beginning with the first plane Vp_1, zooming-in then displays a continuous transition at an increasing resolution or scale. Thus at some point a virtual plane such as second plane Vp_n which is visible at resolution “n” is included in the virtual plane Vp_n and displayed in the graphical user interface.

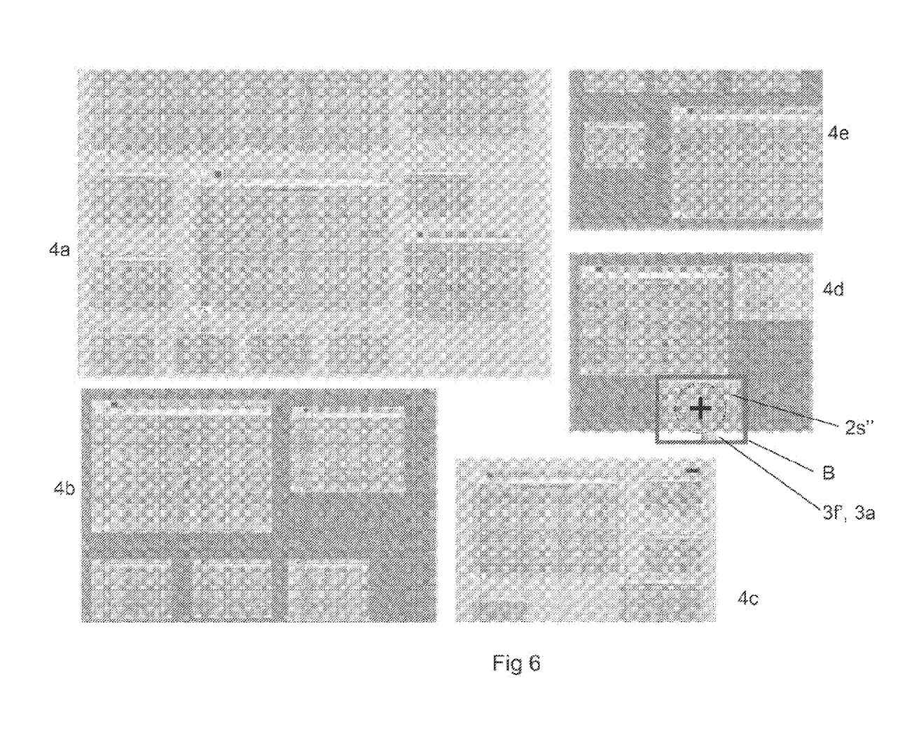

The HMI provided provides a graphic interface which involves: arranging all process information on one zoomable plane (FIG. 1); zooming in/out occurs in smooth and continuous steps showing the operator how process information is placed in relation to process information about other different process sections or different processes, and helping the operator to navigate around the plane;
this feature can be further enhanced by zooming out on all pan-actions to allow the operator to see the ‘larger picture’ of where she was and where she is going;
arranging all other relevant information such as faceplates, trends, alarm lists, documentation, etc alongside the process graphics in the same zoomable plane at the same scale or magnification as the process information;
information objects (sets of process information grouped in some way as eg process graphics and additional objects) can be arranged into strict grids or other suitable arrangement (see below examples of FIGS. 1, and 6);
providing interaction methods for zooming in and out, typically by mouse wheel scrolling, mouse clicking with/without modifier keys, touch screen, touch pad, speech recognition and so on, etc. In the case of large displays user input in the form of gestures or signals may be detected and used; providing interaction methods for panning across the process graphics plane at all zoom levels, typically by clicking and dragging graphics in the plane, arrow keys, etc.

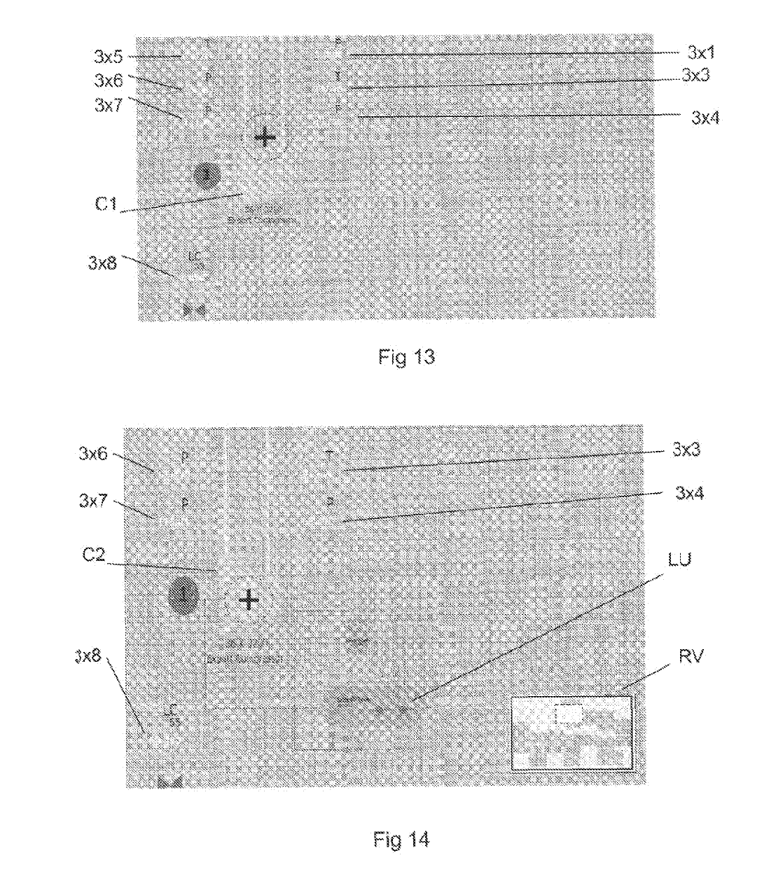

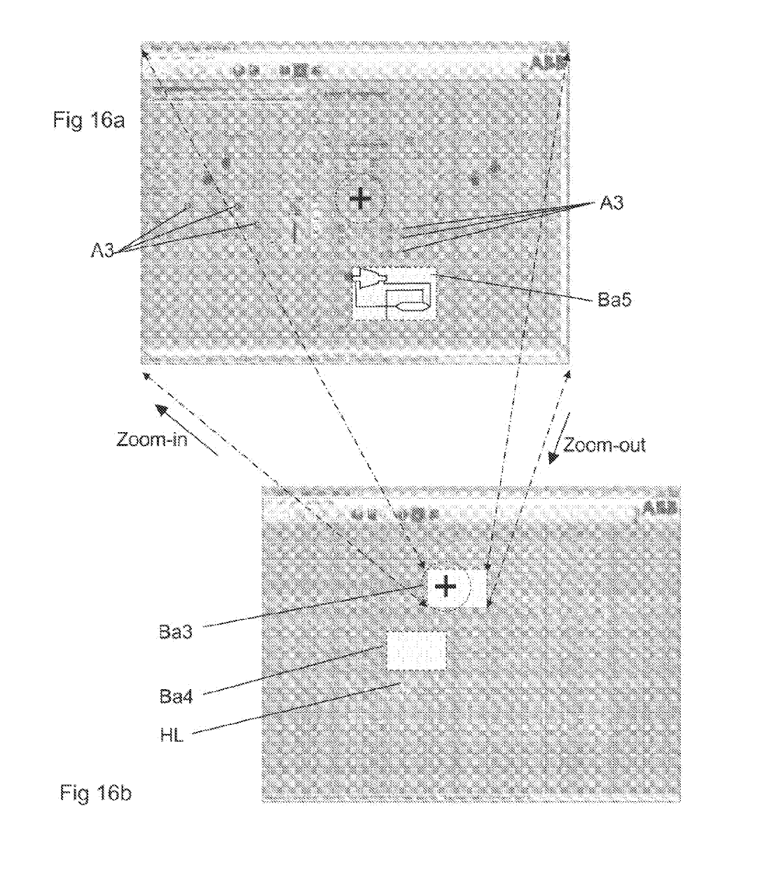

Additional embodiments comprise developments in aspects of the interface such as:
layout: sets or groups of process information representing a process section, such as arranged as a series of process graphics can be laid out according to plant geography, functional connections, ecological interface principles or a number of other schemes (see below in respect of grouping and FIG. 6)
configurable layout of process information on the graphic interface, configuration of layout of eg process graphics according to a user configuration: user can rearrange the layout at will;
system configuration: depending on user's past behaviour and/or preferences or on system events such as alarms, key performance indicator (kpi) values, etc; user can choose between different layout patterns/schemes;
alternative zoom navigation aids such as:
stepwise zooming between predetermined zoom levels;
displaying frames that represent predetermined views (continuous zoom & then stop at a pre-specified position) e.g. process graphic level, process area level showing all process graphics within that area, group of process graphics, process graphics along with surrounding trends, faceplates, etc; part of process graphics showing details of e.g. HP separator
the interface may be arranged to give the visual effect of ‘tilting’ of the zoomable plane of the graphic interface for the operator to see what lies further in that direction;
the interface may be arranged by means of eg computer animation techniques to give the visual effect of flying to another area after user has typed a process graphic name, tag name, id, etc; the flying may also be staggered or semi-delayed such that, similar to the “mouse tails” feature, the previous views of the display fades out slowly thus showing the operator the progress or route that the display views have taken from one part of a process section to another;
abstraction: sets or groups of process information such as the process graphics can be abstracted on zoom-in/-out to allow for more efficient recognition of the graphics and more efficient communication of the technical content of the process information requiring more attention from the operator, such as alarms. For example process graphics can smoothly transform into an icon with text on zoom-out, or certain objects/text can grow in salience, e.g. the main HP separator symbol HL FIG. 16b and text grows in size and darkens in color while the rest fades out or becomes lighter;
level of detail (LOD): less important objects become invisible as one reaches higher zoom levels or as the scaling is increased; more and more information becomes visible as one zooms in;
Heads-up display: in order to keep faceplates and other information in view, they can be ‘docked’ to the monitor so that when the user zooms or pans they still can see the faceplate or other object; the faceplate of other object is superimposed or fixed on top of an otherwise continuously changing navigation view scaling up or scaling down, or panning etc.
Radar view: provides user with visual feedback on where the view is currently located in relation to the ‘big picture’ of the whole process section or the whole plant by use of a small radar view RV area, or other small representation, overlaid or placed close to on the active window and showing in which area of all available process graphics the currently selected part of the first process graphic is located, further described below in relation to FIGS. 13, 14.

The figures show a series of static screenshots taken from a test system, stages or steps from a continuous and dynamic operation. The screenshots are literally snap-shots taken during one or more continuous zooming operations of the interface.

FIG. 1 shows an interface 1 displaying a plurality of process information arranged in this example grouped in a plurality of process graphics 2a-2n laid out on a zoomable plane of a graphic interface, also known as a graphical user interface (GUI). The process graphics in this example are shown laid out in a single view, in this particular example in a grid formation. All of the process graphics displayed on the interface are arranged for continuous zooming in and/or out of the plane of view according to an embodiment of the invention. Process graphic 2s is shown with an associated trend plot 3t, faceplate 3fp, alarm list 3a and documentation 3p. An advantage of this display is that the user can point to an associated grouping of process information, such as the alarm list, and zoom in (or out), or pan, by pointing and zooming and where it is not necessary to first click to select the object. It is not necessary to point then click, it is enough to point and move a joystick or turn a scroll wheel of a computer mouse to start a zoom (or pan) relative to the chosen point. The starting point is illustrated on the display, for example as a cross+inside a dotted circle.

Each set or grouping of process information, such as a process graphic, is arranged with one or more active links which, when selected or activated by an operator, provide control objects for supervision or control. The operator may point to a link to provide a history or a trend, or activate a link to display one or more parameters from the process. Operators may also carry out a control action by activating an active link in the process graphic to, for example, change a valve setting, change a pump speed, thus carry out a control action on a physical object in the process, and so on.

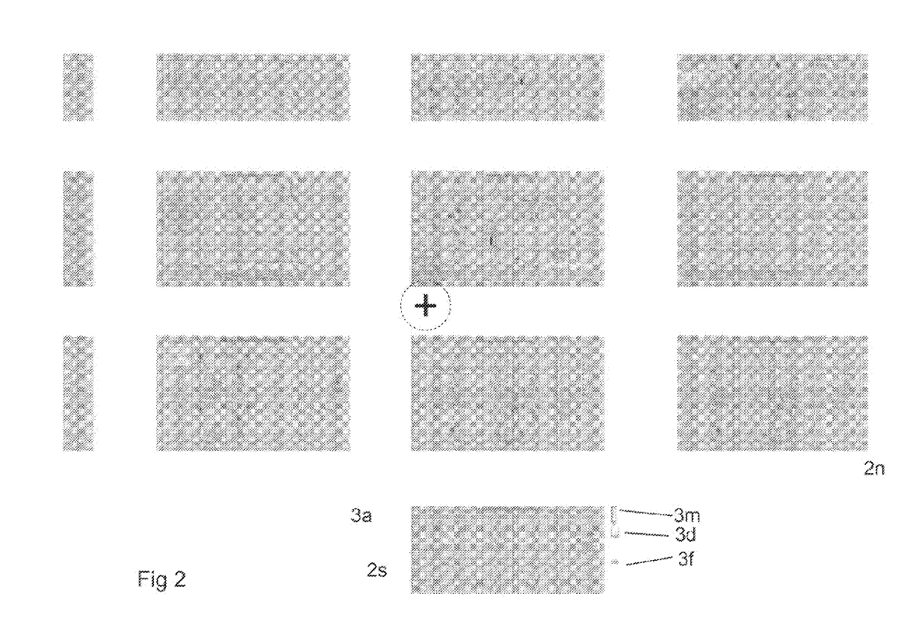

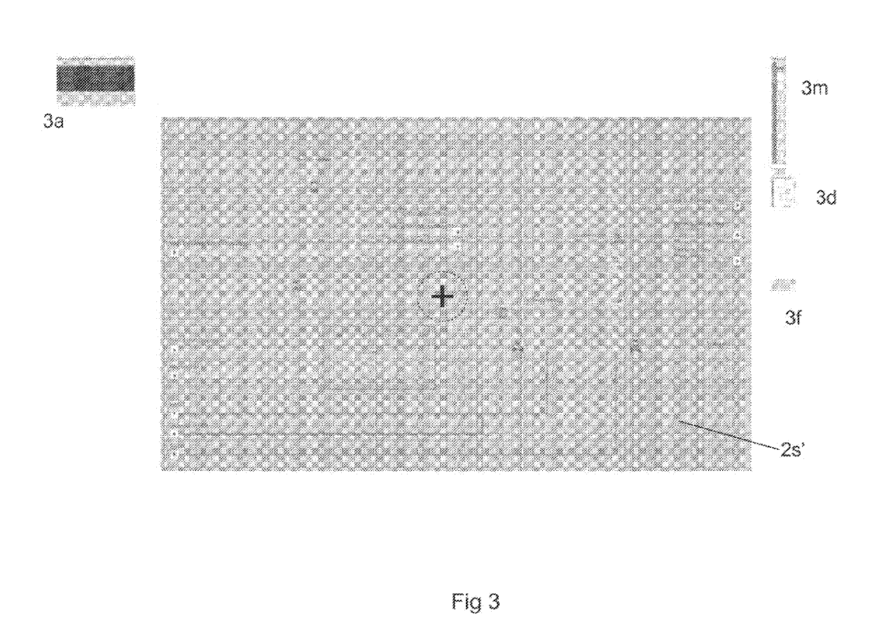

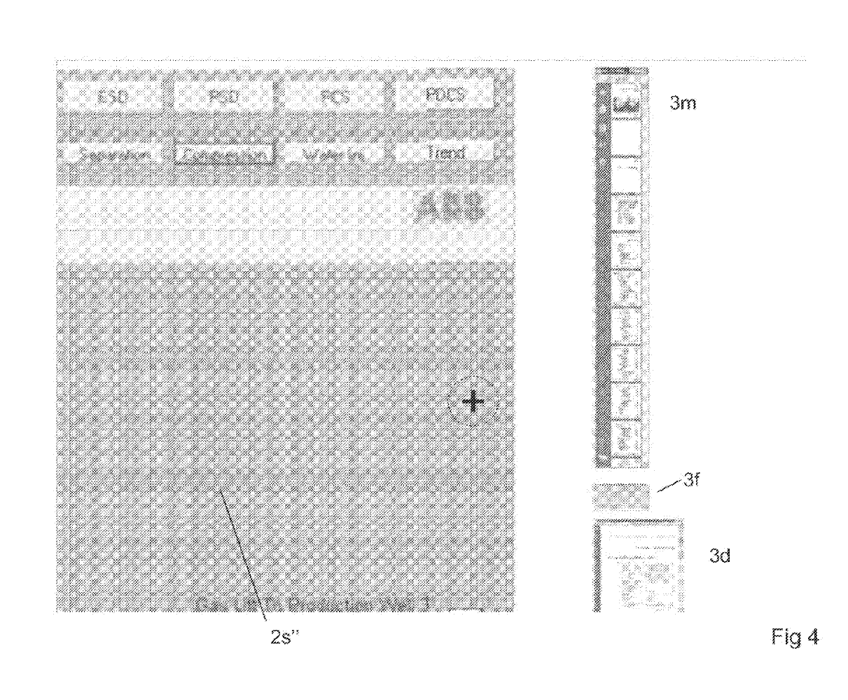

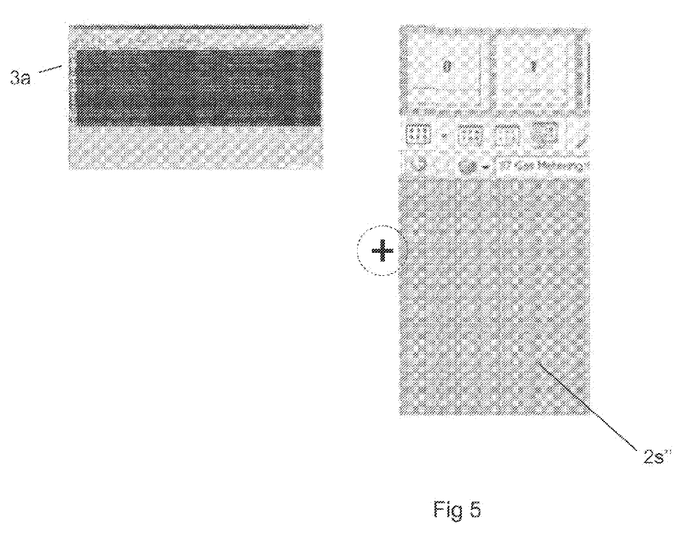

FIG. 2 presents a snapshot while zooming in on process graphic 2s, in which view the associated trend plot 3t, faceplate 3f, alarm list 3a and documentation 3m are also visible. FIG. 3 shows the process graphic 2s of interest zoomed in to fill most of the display area. By means of one operator input the operator has navigated using, for example a computer mouse scroll wheel, to zoom in to one process graphic of interest. The documentation 3m, the alarm list 3a, data sheet 3d are shown in a further zoom-in of FIG. 4. The alarm list 3a is shown in a further zoom-in view of process graphic 2s″ in FIG. 5. Each of FIGS. 2-5 are presented as single snapshots from a single and continuous zoom-in to graphic objects on the HMI graphic interface.

FIG. 6 shows the interface 1 displaying essentially the same process graphics as in FIG. 1 but in this example the process graphics are shown grouped in a some way in groups 4a-4e. Process information group 4d includes a further process information grouping and two associated process information (faceplate, alarm list) objects outlined or emphasised in this drawing by a rectangular box B. Process graphics can be grouped or laid out according to plant geography, functional connections, environmental considerations. For example a process graphics may be grouped according to an operational procedure for a start-up, for a procedure to tune a parameter or optimise a process, a procedure for training, or a procedure for shut-down. All of the process graphics displayed on the interface may be arranged for continuous zooming in and/or out of the plane of view according to an embodiment of the invention.

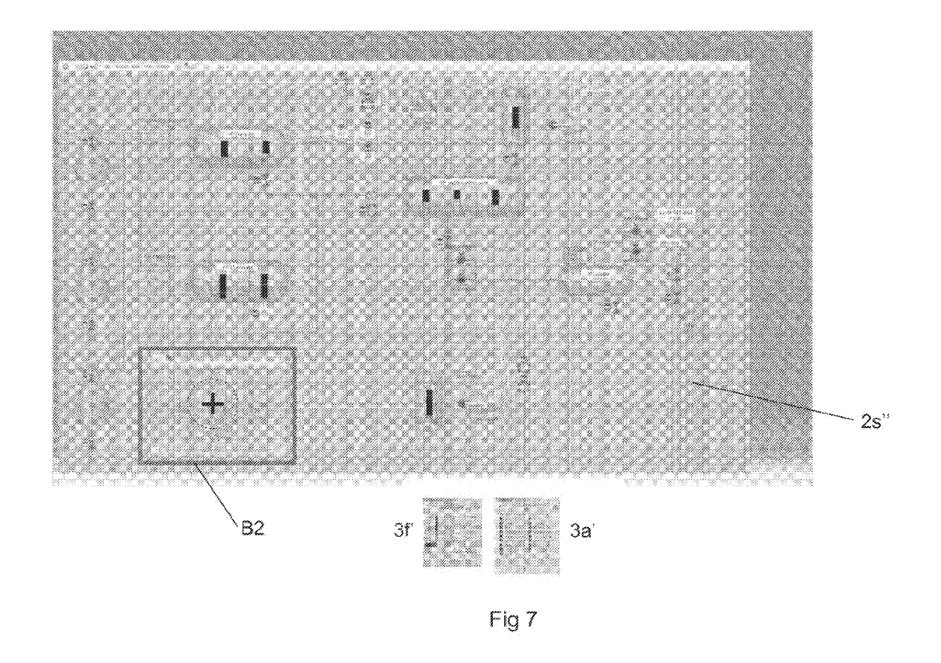

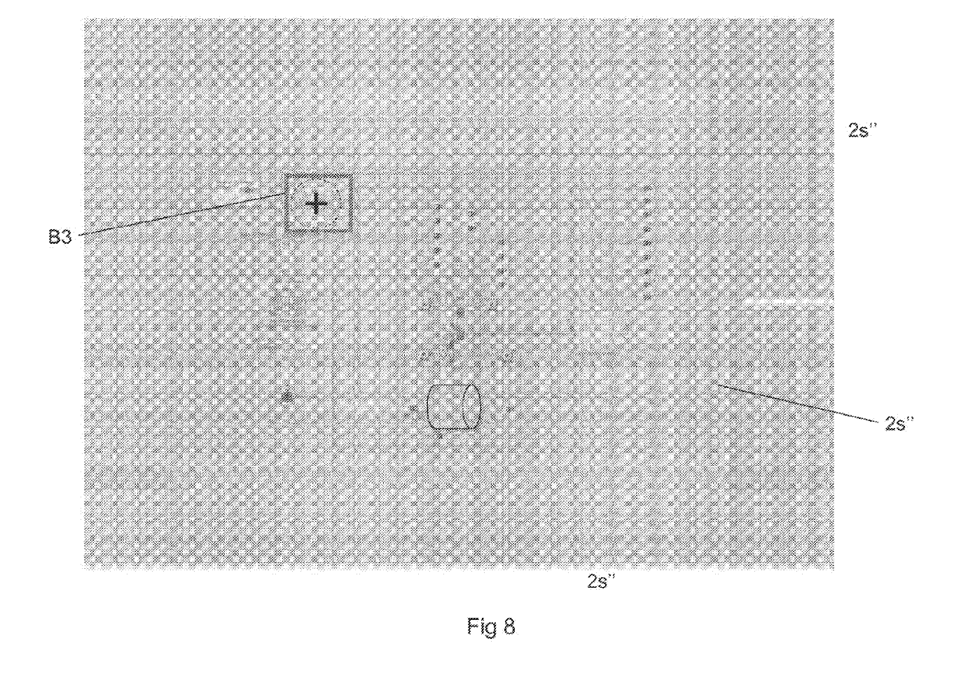

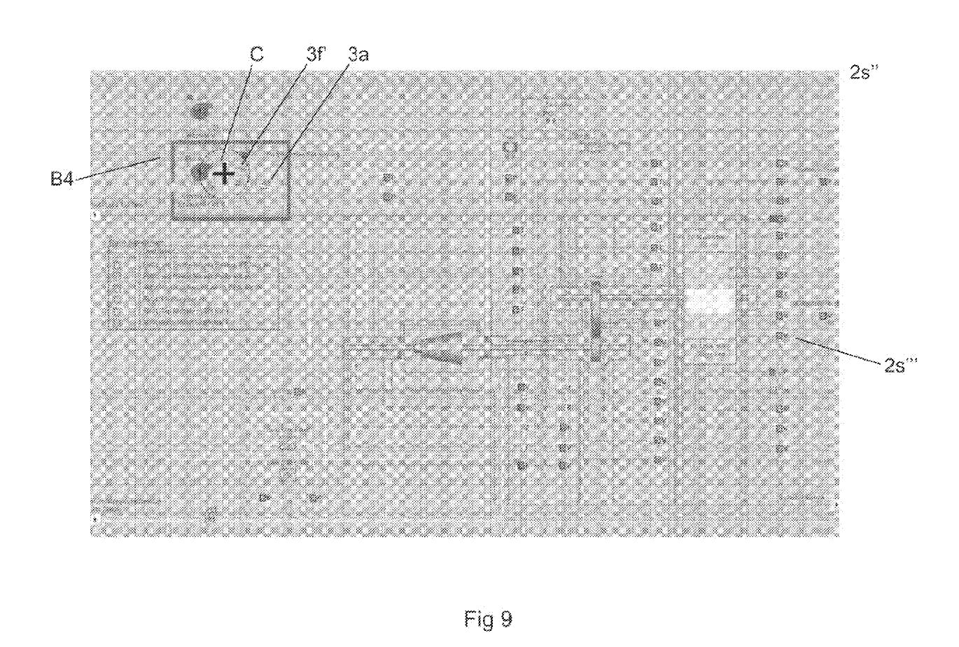

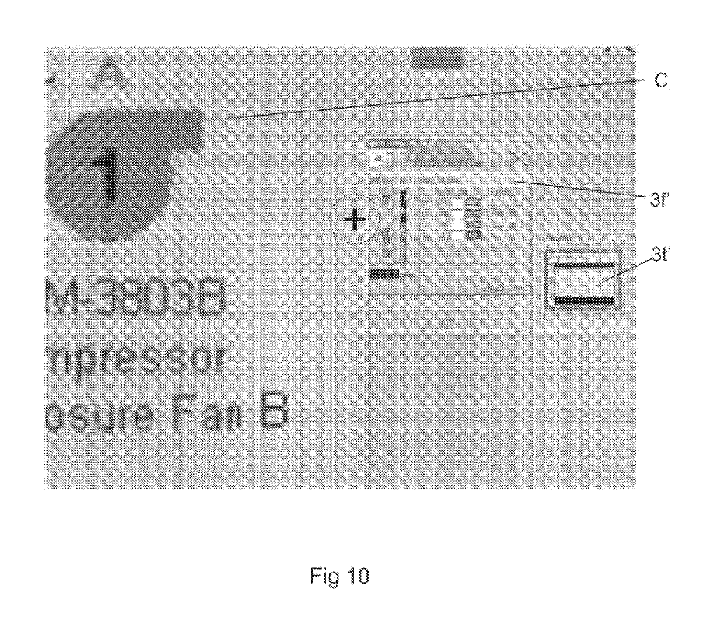

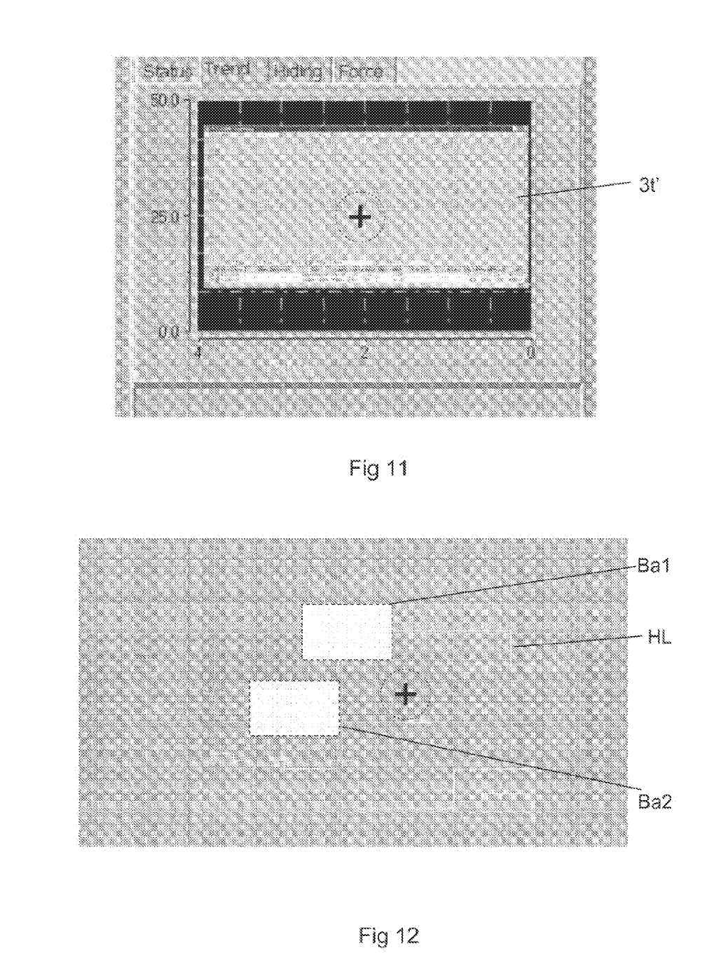

FIG. 7 shows a zoom-in to process graphic 2s″ which contains a greater level of detail again in the graphic marked with a rectangular box B from FIG. 6. In the active window of FIG. 7 with the process graphic 2s″ an associated faceplate 3f and alarm list 3a are also displayed. A further process information grouping is outlined by another rectangular box B2. FIG. 8 shows the zoom-in to box B2 from FIG. 7 in the form of expanded process graphic 2s″ with another, further level of detail indicated on the graphic by box B3′. FIG. 9 is a zoom-in on process graphic 2s′″ with another, further level of detail or resolution, marked by a box B4, in which a compressor C and a faceplate 3f and a trend 3t are displayed. In FIG. 10 the compressor C, faceplate 3f′ and trend 3t′ are shown in a zoomed-in view of box B4 from FIG. 9. A faceplate such as 3f typically makes values and setpoints for a specific equipment available for more direct examination or configuration by an operator. FIG. 11 shows a zoom-in to one of the trends 3t′ of the compressor C from box B4 of process graphic 2s′″.

The continuous zooming function of the graphical user interface may be implemented in different ways and by using a software or a hardware or a combination of hardware and software. The graphical symbols or other graphical representations of the physical process objects may be implemented as computer program produced objects arranged on a large or endless virtual plane (FIG. 18, Vp_1). The individual computer representations of objects or measurements can be made visible or invisible based on zoom level, or scaling, in order to ‘de-clutter’ the view when navigating around the process information objects shown on the plane of the graphic interface. The zoom level (eg zoom in a scale from Zscale_1 to Zscale_n) may be determined by examining the scale of the view displayed, and by making process information objects or measurements etc visible when they are, or would be, displayed at a resolution greater than a certain scale. Correspondingly, when zooming out, objects that become smaller may be made invisible, or reformed into a less-detailed graphic grouping, when the scaling is below a certain value.

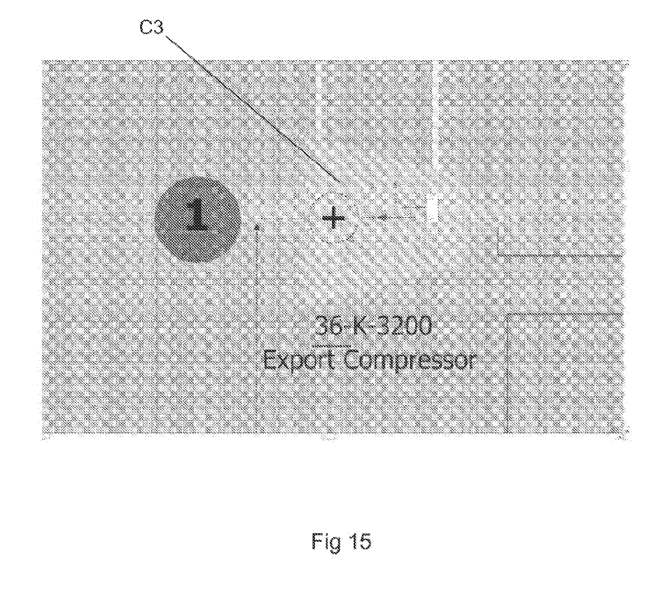

FIGS. 13 and 14 illustrate changing the graphic display as graphic components become too big/small to be easily viewed. FIG. 13 shows process information in a section including a simple graphic form of a process object, a compressor, numbered C1. As a result of zooming in, in FIG. 14 the compressor, shown as C2, is shown together with an outline graphic for an associated process section including in this example a lubrication unit LU. In the same diagram a radar view RV is shown bottom right to illustrate how present process section displayed in the graphical user interface of FIG. 14 may also be shown as a marked out rectangle etc in relation to the whole plant or to a whole process section using the radar view RV graphic display. FIG. 15 shows a further zoom-in towards the compressor, C3, in which additional and process information not previously visible at the previous scale (FIG. 13 or 14) is now made visible in a simplified form superimposed on the compressor graphic.

The navigation functionality may be implemented as modifying the scale of the canvas (eg zoom in a scale from Zscale_1 to Zscale_n) on which all of the process objects are placed, and also by modifying the translation (eg on a scale from pan left PL to pan right PR) of the current view relative to the mentioned canvas. The panning function may also be applied to navigate up and down in the virtual plane, that is to say perpendicular to the both the zoom axis and the Left-Right axis but lying in the plane.

In another embodiment a continuous zoom of a process graphic may also or instead be implemented by means of a method or process described in US 20060033756, entitled “System and method for organizing two and three dimensional image data” and assigned to ABB, which description is hereby incorporated in full in this description by means of this reference.

In another embodiment a continuous zoom of a process graphic may also be implemented by switching one at a time to a series of stored high resolution images of process information arranged grouped as a plurality of process graphics which are arranged based on a new or amended process and instrumentation (P & ID) diagram. The new P & ID diagrams may be designed to take advantage of the continuous zooming methods and the processes and sub-processes arranged from the beginning in functional or other groupings to provide both complete overviews and selective access to control objects by continuous zooming. The process graphics may include images showing all equipment or process elements in a process; or showing a complete plant, such that one or more images are arranged to represent the process or plant as one whole process graphic that demonstrates a total overview of the process (or plant).

The process information of the HMI may be visually organized on an infinite virtual plane that may be panned, for example panning left or panning right relative to a point of interest, as well as can be seamlessly, continuously and smoothly zoomed in and out. The process graphics may be arranged as one single line or row of process graphics extending almost endlessly to the left and right. The process graphics may be arranged as a grid as shown in FIG. 1, or in another grouping showing, for example a functional or process based layout. For example a pulp and paper process including a paper machine may be represented as one long single line of process sections arranged in a single eg horizontal across the zoomable plane. Panning left or right quickly displays a series of process sections to the operator according, in this example, to process section layout in the plant. In addition, different process sections of the pulp and paper process may also be represented according to physical location of one or more process sections in the plant, where navigation may be done by pointing to a point of interest in a radar view such as the example RV shown in FIG. 14. In the radar view the user may point or otherwise indicate to parts of a simplified view from eg above of one or more process sections and then with a scroll wheel or joystick input zoom-in to a desired section.

In another embodiment representations of alarm events are integrated into the operator interface, which alarm representations are aggregated into a larger and simplified visualization when the view is zoomed out. When the individual alarms in the process sections currently display become too small to be seen by the operator the aggregation takes place. This may be driven by monitoring the scaling of the image, and that when the scale falls below a certain size, the aggregation is triggered. The advantage here is to represent whether there are alarms within process section, physical location, a process graphic or other logical grouping of process information objects, instead of showing each individual alarm spread out across the whole plant when viewing a top-level overview. The function may be implemented in a systematic way such that a manual configuration of each of hundreds of process graphics is not necessary. Instead of a function configured manually for each alarm the aggregation is implemented as a feature of the navigation system. It is thus to some extent automatically or at least semi-automatically configured when the individual process control objects, each tag name, are first included in the control system

FIG. 12 shows a zoomed-out, or less-detailed view, from a process section. Two process sections in the view are shown as a marked area, which on the drawing is additionally indicated by rectangular boxes Ba1, Ba2 with point shading. The marked areas are process sections with aggregated alarms, that is where the individual alarms have been made invisible and aggregated so that the process section in which they occur are visible in a less detailed process context. The aggregation function may also superimpose more information on the less-detailed process view process sections or functions connecting or associated with the aggregated alarms. In this example main functional connections in the process system are also marked out using a highlight HL and/or eg different colour. This is also shown in FIGS. 16a, 16b where FIG. 16a is a zoomed-in display of FIG. 16b, and thus FIG. 16b is zoomed-out display of FIG. 16a. Thus FIG. 16b shows a zoomed-out (less detailed) view of process information including two process areas with aggregated alarms, marked on the drawing with boxes Ba3, Ba4. Part of the process is also shown highlighted HL or in a different colour.

FIG. 16a shows a zoom-in to one of the process sections Ba3 displayed with a representation indicating aggregated alarms. FIG. 16a shows a process section with a plurality of individual alarms A3 indicated by representations of eg red-coloured lamps. These several alarms A3 in the process section are thus aggregated to a simplified visible indicator Ba3 in the zoom-out shown in FIG. 16b, FIG. 16a shows in addition a process section with a simplified graphic and aggregated alarms.

In another embodiment the subscription to real time data via protocols such as OPC, the setup and deletion of subscriptions are automatically handled by linking it to the visibility of any representations using this real time data value. This may be done by linking every OPC subscription with a set of zoom and translation variables, such that when the current view is within the given limits for a specific OPC tag, it would be subscribed to, and as soon as the current view moves outside the region specified for the individual OPC tag, it would be removed from the subscription list. FIG. 13 shows a view of a process section with parameter values 3×1, 3×3, 3×4, 3×5, 3×6, 3×7 and 3×8 some of which may be real-time values. An Export Compressor C1 marked with a numeral 1 is indicated as a simple graphic labelled with text. FIG. 14 shows a zoom-in to the same point in the process section.

FIG. 14 shows new process information in the zoom-in, the lube oil system LU, in a simplified graphic format for the less detailed, low magnification image. In a practical example only OPC items 3×43, 3×4, 3×6, 3×7 and 3×8 would be subscribed to when zooming in on a detail such as e.g. in FIG. 14. This has the advantage of reducing network traffic and computational resource usage as only relevant real-time values are subscribed to, instead of subscribing to all real-time values at all times. This has the advantage of removing unnecessary visual clutter from the graphical user interface and simplifying the process information displayed to an operator. In other words, each particular OPC value is only subscribed to if the view is within specified zoom & translation variables for this variable. The relevant zoom and translation variables may be automatically configured for each graphical element during the engineering, where the translation variables are related to the position directly, and the zoom variable may be computed also based on which type of visualization it is. The feature of making a subscription to an OPC value, a real time data subscription or a historic etc data value may be summarised as:
linking a data value subscription with a set of zoom and translation variables, such that when the current view of a graphical user interface comprising a specific data value identity or OPC tag is within predetermined limits of the zoom and translation variables, the specific data value identity or OPC tag would be subscribed to, and as soon as the current view moves outside the predetermined zoom and translation limits specified for the specific individual data value identify or OPC tag, it would be removed from the subscription list. The observed result would be that the subscribed data value becomes visible on the interface display when the data value subscribed to would be of a sufficient size that it could be seen by the operator, and removed as it becomes too small to read.

For example, a historic or real time value in e.g. a numeric display will have different visibility requirements than a bar graph or trend element that would be useful from a higher distance/zoom level. FIG. 15 shows the export compressor of FIGS. 13, 14 after further zoom-in where the simplified graphic format of the export compressor has been scaled up to show related process information C2 and in more detail. The process information C2 may also be zoomed-in to.

In a variation of the embodiment the smooth and continuous animation movement may be varied. In particular, a slower zoom may be generated so that the visual transitions are made to appear more slowly, and the previous visual images arranged to fade out more slowly, so that an impression of where the present visible display has transformed from is visibly presented. This has been found to assist understanding of the process control context of some monitoring and control operations. It is also advantageous to select a zoom in or zoom out action that advances as a continuous series of steps. The zoom-in stops and waits and restarts at predetermined intervals, providing a stepwise examination of a series of process sections during a long zoom-in or zoom-out. The advantage of a continuously stepwise zoom is that the boundaries of one or more process sections are easily observed by an operator. When the operator can see which boundaries are coming up it gives the user more information about the present and coming process sections and thus makes user navigation to a desired point of interest simpler and more direct. For example an operator may point to a point of interest and double-click a computer mouse or similar to start a zoom-in or a zoom-out the process section to a predetermined level.

A unique identifier of a process object in plant, a process object such as a specific valve or sensor or controller etc in a process section is often described as a tag name. Usually a tag name is in an alphanumeric form such as eg 27-PIC-4422. A tag name may be structured to contain some information about the process object, such as in the example 27-PIC-4422 the 27 may represent a system number, PIC an object type, then a running number 4422 for each of the objects of that type in the whole plant.

In another embodiment of the graphical user interface when searching for a process object using a text search on a tag name, the tag search results of any incremental or absolute search could be visualized directly in the zooming graphical interface e.g. by showing a tool-tip or other pop-up or in-place visual symbol that shows the text meeting the current search criteria—possibly in addition to a search result list. Furthermore, the view in the zooming graphic interface showing process information, process sections or process graphics would, at the same time, zoom in/out according to the spatial position of the search results—so that the smallest possible view that includes all search results is viewed. In the case of an incremental search—where a new search is performed for every keystroke from the user—the view may be continuously zoomed in showing all tags that meet the criteria. In a practical example, if the user wants to find all tags that contain −013, after the first keystroke (“−”) the view is zoomed to include all tags that hold a (“−”), at the next keystroke (“0”) the view is zoomed further in to include only all tags that hold (“−0”), at the third keystroke (“1”) the view is zoomed in to view all tags that contain (“−01”) and finally at the fourth keystroke (“3”) the view is zoomed in to a as-small-as-possible view that still shows all tags that contain (“−013”). The zooming graphical user interface for process control is especially well suited for automatically adjusting the view (zoom & translation variables) based on the results of the incremental search (here the word ‘incremental’ means that a search is performed for each keystroke as opposed to only when the ‘apply’ command is sent), so that at any time each item in the search results list is visible and highlighted in the view.

This type of search result visualization provides contextual information for the operator so that he/she can more clearly identify the desired item in the list of search results.

When the distribution of search results is such that the view is zoomed too far out to see surrounding info for each search result, a ‘magnifying glass’ or other additional type of display window might be provided for each result to view the context of the search result clearly.

This embodiment may be summarised in method form as registering a text input to a search for a process or control object, finding a match or part-match depending on a first character of the registered text, and displaying a view of process information containing process objects with a name or label containing the matched character, or characters of the registered text. The advantage of the above integration of a text-based search engine floating superimposed on a display of the graphic interface of the control systems is that the process context of each type of tag name is displayed during the progress of the search, showing step-by-step the operator the technical process context and/or physical location for different control objects as represented by the tag names.

The methods of generating and providing a graphical user interface as described in this specification may be carried out by a computer application comprising computer program elements or software code which, when loaded in a processor or computer, causes the computer or processor to carry out the method steps. The computer, or a microprocessor (or processors) connected to it, comprises a central processing unit CPU performing the steps of the method according to one or more facets of the invention. This is performed with the aid of one or more said computer programs, such as, which are stored at least in part in memory and as such accessible by the one or more processors. The program or programs may run in a local or central control system in a local or distributed computerised control system. It is to be understood that said computer programs may also be run on one or more general purpose industrial microprocessors or computers instead of one or more specially adapted computers or processors.

The computer program comprises computer program code elements or software code portions that make the computer perform the method of providing a graphical user interface using equations, algorithms, data, stored values and calculations previously described. The program in part or in whole may also be stored on, or in, other suitable computer readable medium such as a magnetic disk, such as a CD (compact disc) or a DVD (digital versatile disc), hard disk, magneto-optical memory storage means, in volatile memory, in flash memory, as firmware, stored on a data server or on one or more arrays of data servers. Other known and suitable media, including removable memory media such as Sony memory stick™ and other removable flash memories, hard drives etc. may also be used.

It should be noted that while the above describes exemplifying embodiments of the invention, there are several variations and modifications to the graphical user interface, and in particular to different methods of registering user input to the graphical user interface which may be made to the disclosed solution without departing from the scope of the present invention as defined in the appended claims.

1. A method for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, characterised in that the interface is arranged with navigation means so that a user can indicate or select at least one point in a process section on said graphical user interface as a first user input and increase, in a continuous animated movement, the scale at which the at least one point and its immediate surroundings in the process section are displayed, and further displaying a view of the indicated or otherwise selected point on said graphical user interface and scaling up continuously until a predetermined scale is reached or a second user input is received, and displaying a scaled-up view of the indicated or otherwise selected at least one point at the scaled-up level thus reached.

2. The method according to claim 1, characterised by calculating, upon receiving the first user input to zoom in, an adjustment to scale of resolution for the process section on said graphical user interface including the indicated or selected at least one point.

3. The method according to claim 1, characterised by visibly displaying in the scaled up view on said graphical user interface the indicated or selected at least one point any text information that is in a predetermined size range.

4. The method according to claim 1, characterised by visibly displaying in the scaled up view on said graphical user interface of the indicated or otherwise at least one selected point a graphic form or information that is within a predetermined size range.

5. The method according to claim 1, characterised by scaling the at least one indicated or selected point on said graphical user interface by scaling up a vector based graphic image of one or more parts of said first process graphic.

6. The method according to claim 1, characterised by scaling the at least one indicated or selected point on said graphical user interface by scaling up a vector based graphic displaying the selected image on the fly, in real time.

7. The method according to claim 1, characterised by increasing the display resolution smoothly and continuously for the at least one indicated or selected point on said graphical user interface until a maximum scale value is reached and overlaying new information objects which comprises more detailed information not displayed under magnification of the point or points while scaling up to the maximum scale value.

8. The method according to claim 1, characterised by increasing the display resolution on said graphical user interface smoothly and continuously for the at least one indicated or selected point until a scale value is reached at which point a detailed process information in a process section displayed with aggregated alarms becomes visible to an operator and changing from the aggregated graphic form to a detailed process information form showing one or more of the previously alarms in more detail.

9. The method according to claim 1, characterised by increasing the display resolution on said graphical user interface smoothly and continuously for the at least one indicated or selected point until a scale value is reached at which point one or more data values become visible to an operator and then opening a data subscription for the latest or real-time values to each data value.

10. The method according to claim 1, characterised by receiving a first user input to zoom-out from the at least one indicated or selected point on said graphical user interface, decreasing the display resolution of the selected part of the first process graphic in a smooth and continuous way and de-magnifying the at least one indicated or selected point until a predetermined scale is reached or a second user input is received, and displaying the control object at the magnification level reached at end of user input.

11. The method according claim 1, characterised by decreasing the display resolution for the at least one indicated or selected point and zooming out smoothly and continuously until a predetermined reduced scale is reached or a user input is received.

12. The method according to claim 1, characterised by zooming out from the at least one indicated or selected point and changing, when one or more values provided by data subscription become too small to be seen by the operator, the data subscriptions for the values no longer visible.

13. The method according to claim 1, characterised by zooming out from the at least one indicated or selected point and changing, when one or more displayed alarms become smaller than a preset minimum scaling threshold, to aggregate the displayed alarms into a another form display showing in which process section the previously displayed alarms belong.

14. The method according to claim 1, characterised by moving to a scaled up or scaled down view from the at least one indicated or selected at least one point on said graphical user interface and displaying the scaled up or scaled down view of process information overlaid in a semi-transparent manner on top of the first view of the indicated or selected point on said graphical user interface.

15. The method according to claim 1, characterised by moving to a scaled up or scaled down view of process information from said at least one indicated or selected point and fading in the scaled up or scaled down view of the process information until it is overlaid in a semi-transparent manner over the magnified/demagnified selected part of the indicated or selected point on said graphical user interface.

16. The method according to claim 1, characterised by increasing or decreasing the display resolution smoothly and continuously until one or more predetermined scale or resolution stage is reached and then pausing the continuous smoothing at a stage predetermined to contain process information about any from the group of: a detail level; a process section level; process area level showing all process information and graphics within that area; functional group of process graphics, selected process information or process graphic graphics along with surrounding trends, faceplates; part of process information graphics showing details of a specific equipment.

17. The method according to claim 16, characterised by increasing or decreasing the display resolution smoothly and continuously until one or more predetermined scale or resolution stage is reached and then pausing the continuous smoothing each time a predetermined process information stage is reached, the stage being any from the group of: a detail level; a specific equipment; a functional group of process graphics, a process section level; a combination of process sections.

18. The method according to claim 1, characterised by displaying a small representation overlaid on the active window showing in which area of all available process sections the currently selected part of the zoomed-in or zoomed out process information or process section is located.

19. The method according to claim 1, characterised by displaying additional windows or control objects adjacent to a process graphic, the control objects being any from the group of: alarm list, trend, faceplate, live video feed, a picture, a 3D model, documentation.

20. The method according to claim 1, characterised by displaying at least one first process graphic of a process control system in an active window, and on receiving a user input to pan by panning in one direction or in a reverse direction over an extended artificial horizon extending almost up to 360 degrees.

21. The method according to claim 1, characterised by panning by means of a user input to the left or the right over an artificial horizon extending up to 360 degrees or more displaying process information or process graphics for a complete sequence of process stages or steps.

22. The method according to claim 1, characterised by navigation means so that a user can indicate or select two or more points in a process section and zoom out continuously in one movement until the region between the two points fills the display area of a display screen.

23. A process control system comprising a computer arranged with said process control system comprising a workstation and one or more input devices for registering user input and a display apparatus arranged for displaying a graphical user interface with a plurality of graphic objects each associated with a process control object wherein at least one graphic object has an active link for monitoring or controlling at least one physical control object, characterised in that said graphical user interface is arranged with navigation means so that a user can indicate or select at least one point on said graphical user interface as a first user input and increase the scale in a continuous animated movement at which the at least one point is displayed, and further displaying a view of the indicated or otherwise selected at least one point on said graphical user interface and scaling up continuously until a until a predetermined scale is reached or a second user input is received, and displaying a scaled-up view of the indicated or otherwise at least one selected point at the scaled-up level thus reached.

24. The process control system according to claim 23, characterised in that a computer mouse or similar input device may be used to indicate at least one point to be zoomed-in, or zoomed-out from, by any user action from the group of: scroll wheel up/down; button press, joystick movement, handheld control apparatus movement.

25. The process control system according to claim 23, characterised in that a touch screen input device may be used by a user to indicate at least one point of interest by any user action with a hand or hands from the group of: touch, touch and move, touch in two places and move, tap, tap and move.

26. The process control system according to claim 23, characterised in that a gesture by the user may be registered by a detection device and used by a user to indicate at least one point of interest on said graphical user interface.

27. The process control system according to claim 23, characterised in that a computer input device may be used by a user to register an instruction to pan to the left or to the right on said graphical user interface.

28. The process control system according to claim 27, characterised in that a panning movement instruction may be made by a user to pan on said graphical user interface to a predetermined translation point left or right.

29. The process control system according to claim 27, characterised in that a panning movement instruction may be made by a user to pan on said graphical user interface to a predetermined translation point left or right and a predetermined scale or resolution.

30. The process control system according to claim 23, characterised in that said graphical user interface is arranged suitable to receive user input from a user input apparatus such that a user may signal at least one point of interest on said graphical user interface.

31. A computer program product directly loadable into the internal memory of a digital computer comprising software code portions for performing, when said product is run on a computer, a method for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, characterised in that the interface is arranged with navigation means so that a user can indicate or select at least one point in a process section on said graphical user interface as a first user input and increase, in a continuous animated movement, the scale at which the at least one point and its immediate surroundings in the process section are displayed, and further displaying a view of the indicated or otherwise selected point on said graphical user interface and scaling up continuously until a predetermined scale is reached or a second user input is received, and displaying a scaled-up view of the indicated or otherwise selected at least one point at the scaled-up level thus reached.

32. A processing unit in a computer based system, the processing unit having an internal memory with a computer program product loaded therein, comprising software code portions for performing a method for navigating in a process control system for monitoring and control of a process comprising a plurality of physical objects, said process control system comprising a graphical user interface with a plurality of graphic objects each associated with a process control object wherein at least one graphic object has an active link for monitoring or controlling at least one physical control object, characterised in that the interface is arranged with navigation means so that a user can indicate or select at least one point in a process section on said graphical user interface as a first user input and increase, in a continuous animated movement, the scale at which the at least one point and its immediate surroundings in the process section are displayed, and further displaying a view of the indicated or otherwise selected point on said graphical user interface and scaling up continuously until a predetermined scale is reached or a second user input is received, and displaying a scaled-up view of the indicated or otherwise selected at least one point at the scaled-up level thus reached.

33. Use of a process control system for any from the group of: checking a status of an industrial device, engineering an industrial device, making a calculated change to a set point or control parameter for an industrial device, configuring an automation device, controlling an automation device, tuning a process, checking a process variable, teaching a robot, and editing a robot program, the process control system comprising a computer arranged with said process control system comprising a workstation and one or more input devices for registering user input and a display apparatus arranged for displaying a graphical user interface with a plurality of graphic objects each associated with a process control object wherein at least one graphic object has an active link for monitoring or controlling at least one physical control object, characterised in that said graphical user interface is arranged with navigation means so that a user can indicate or select at least one point on said graphical user interface as a first user input and increase the scale in a continuous animated movement at which the at least one point is displayed, and further displaying a view of the indicated or otherwise selected at least one point on said graphical user interface and scaling up continuously until a until a predetermined scale is reached or a second user input is received, and displaying a scaled-up view of the indicated or otherwise at least one selected point at the scaled-up level thus reached.

34. Use of a process control system for retrieving technical data for devices used in conjunction with from any the list of: industrial production; metal production; pulp and paper manufacture; automated industrial processes; oil and gas production, upstream or downstream processes;
chemical industry equipment and processes, vehicle manufacturing, and vehicle assembly, the process control system comprising a computer arranged with said process control system comprising a workstation and one or more input devices for registering user input and a display apparatus arranged for displaying a graphical user interface with a plurality of graphic objects each associated with a process control object wherein at least one graphic object has an active link for monitoring or controlling at least one physical control object, characterised in that said graphical user interface is arranged with navigation means so that a user can indicate or select at least one point on said graphical user interface as a first user input and increase the scale in a continuous animated movement at which the at least one point is displayed, and further displaying a view of the indicated or otherwise selected at least one point on said graphical user interface and scaling up continuously until a until a predetermined scale is reached or a second user input is received, and displaying a scaled-up view of the indicated or otherwise at least one selected point at the scaled-up level thus reached.

35. Use of a process control system for retrieving technical data for devices used in conjunction with from any the list of electricity generation, transmission, transformation, and distribution, the process control system comprising a computer arranged with said process control system comprising a workstation and one or more input devices for registering user input and a display apparatus arranged for displaying a graphical user interface with a plurality of graphic objects each associated with a process control object wherein at least one graphic object has an active link for monitoring or controlling at least one physical control object, characterised in that said graphical user interface is arranged with navigation means so that a user can indicate or select at least one point on said graphical user interface as a first user input and increase the scale in a continuous animated movement at which the at least one point is displayed, and further displaying a view of the indicated or otherwise selected at least one point on said graphical user interface and scaling up continuously until a until a predetermined scale is reached or a second user input is received, and displaying a scaled-up view of the indicated or otherwise at least one selected point at the scaled-up level thus reached.
